(19) United States
(12) Patent Application Publication
(10) Pub. No.: US 2012/0310737 A1
(43) Pub. Date: Dec. 6, 2012

(54) METHOD FOR PROVIDING ADVERTISEMENT, COMPUTER-READABLE MEDIUM INCLUDING PROGRAM FOR PERFORMING THE METHOD AND ADVERTISEMENT PROVIDING SYSTEM

(75) Inventors: Junehwa SONG, Daejeon (KR); Jin-Young Ha, Chuncheon (KR); Yunseok Rhee, Yongin (KR); Byoungjip Kim, Daejeon (KR); SangJeong Lee, Daejeon (KR); Seungwoo Kang, Daejeon (KR); Youngki Lee, Daejeon (KR)

(73) Assignee: Korea Advanced Institute of Science and Technology, Daejeon (KR)

(21) Appl. No.: 13/224,062

(22) Filed: Sep. 1, 2011

(30) Foreign Application Priority Data
Jun. 3, 2011 (KR) 10-2011-0053693

(51) Int. Cl. G06Q 30/00; G06N 5/02

(52) U.S. Cl. 705/14.57

(57) ABSTRACT

A visit-pattern-aware mobile advertising system is provided for urban commercial complexes. In order to provide highly relevant advertisements to mobile users, next visit place is predicted through a probabilistic reasoning technique based on the collected visit place history, and an advertisement to be provided is selected based on the predicted next visit place. Since the advertisement is selectively provided according to the next visit place predicted based on a visit place history of an advertisement receiver, it is possible to increase an advertisement effect.

### CROSS-REFERENCE TO RELATED APPLICATIONS

This application claims priority under 35 U.S.C. §119 to Korean Patent Application No. 10-2011-0053693, filed on Jun. 3, 2011, in the Korean Intellectual Property Office, the disclosure of which is incorporated herein by reference in its entirety.

### TECHNICAL FIELD

The present invention relates to a method for providing advertisement, and more particularly, to a method for providing an advertisement through mobile apparatuses, a computer-readable medium including a program for performing the method, and an advertisement providing system.

### BACKGROUND

As smartphones have become prevalent, mobile advertising is getting significant attention as being not only a killer application in future mobile commerce, but also as an important business model of emerging mobile applications to monetize them.

Accordingly, research on more efficient and effective mobile advertising is strongly required to meet the requirements of both advertisers and mobile users in the upcoming new mobile era.

### SUMMARY

An exemplary embodiment of the present invention provides a method for providing an advertisement including: collecting a visit place history of a mobile apparatus; predicting a next visit place through a probabilistic reasoning technique based on the collected visit place history; and selecting an advertisement to be provided based on the predicted next visit place.

The collecting of the visit place history may include: detecting a current location of the mobile apparatus; and generating the visit place history of the mobile apparatus based on the detected current location.

The detecting of the current location of the mobile apparatus may include: scanning a Wi-Fi signal through the mobile apparatus; generating a Wi-Fi fingerprint of the scanned Wi-Fi signal; selecting Wi-Fi data based on the generated Wi-Fi fingerprint by searching a Wi-Fi database; and measuring the current location of the mobile apparatus based on the selected Wi-Fi data.

The Wi-Fi data may include a signal strength of a Wi-Fi access point (AP), an identification number of the Wi-Fi access point (AP), and locational information of the Wi-Fi access point.

The generating of the visit place history of the mobile apparatus may include: measuring a duration of the measured current location; comparing the measured duration with a visit threshold time; and regarding the measured current location as a visit place when the measured duration is more than the visit threshold time.

The generating of the visit place history of the mobile apparatus may further include setting the visit threshold time to be compared with the measured duration.

The predicting of the next visit place through the probabilistic reasoning technique may include probabilistically predicting the next visit place through a Bayesian network.

The Bayesian network may be modeled by including a plurality of visit places as variables. The predicting of the next visit place through the Bayesian network based on the collected visit place history may include: calculating a visit probability distribution for the plurality of visit places through the Bayesian network based on the one or more visit place histories; and determining a priority of the next visit place based on the calculated visit probability distribution.

The probability distribution model of the Bayesian network may be learned based on the visit place histories of the corresponding advertisement receiver.

The probability distribution model of the Bayesian network may be learned based on the visit place histories of other advertisement receivers.

The Bayesian network may be modeled by further including the ages of the advertisement receiver as a variable. The visit probability distribution may be calculated based on the one or more visit place histories and the ages.

The Bayesian network may be modeled by further including the gender of the advertisement receiver as a variable. The visit probability distribution may be calculated based on the one or more visit place histories and the gender.

The Bayesian network may be modeled by further including a current time as a variable. The visit probability distribution may be calculated based on the one or more visit place histories and the current time.

The Bayesian network may be modeled by further including a visit duration as a variable. The visit probability distribution may be calculated based on the one or more visit place histories and the visit duration.

The selecting of the advertisement to be provided may include preparing an advertisement list relating to the next visit place based on the determined priority.

The method may further include providing advertisements included in the prepared advertisement list to the mobile apparatus according to the priority.

The method may further include collecting advertisement providing statistics data relating to the provided advertisement.

The advertisement providing statistics data may include at least one of the total number of issued provided advertisements, the number of times in which the advertisement receiver uses the provided advertisement, and the number of times of purchases generated by providing the advertisement.

Another exemplary embodiment of the present invention provides a computer-readable recording medium including a program for executing an advertisement providing method. The advertisement providing method includes: collecting a visit place history of a mobile apparatus; predicting a next visit place through a probabilistic reasoning technique based on the collected visit place history; and selecting an advertisement to be provided based on the predicted next visit place.

The visit place history may be collected by a Wi-Fi fingerprint of a Wi-Fi signal received through the mobile apparatus.

The predicting of the next visit place through the probabilistic reasoning technique based on the collected visit place history may include probabilistically predicting the next visit place based on a conditional probability distribution of a Bayesian network. The next visit place may be determined based on the conditional probability distribution of the Bayesian network. The probability distribution model of the Bayesian network may be learned based on the visit place histories of advertisement receivers.

The advertisement providing method may further include providing the selected advertisement to the advertisement receiver.

Yet another exemplary embodiment of the present invention provides an advertisement providing system including: an advertising client and an advertising server. The advertising client collects a visit place history to provide the collected visit place history to an advertising server and receives an advertisement from the advertising server. The advertising server predicts a next visit place through a Bayesian network based on the visit place history received from the advertising client and provides the advertisement to the advertising client based on the predicted next visit place.

The advertising client may include: a location detector; and a visit history generator. The location detector may detect a current location. The visit history generator may generate the visit place history based on the detected current location.

The location detector may generate a Wi-Fi fingerprint by scanning a Wi-Fi signal, and select Wi-Fi data based on the generated Wi-Fi fingerprint and measure the current location based on the selected Wi-Fi data.

The visit history generator may measure a duration of the measured current location and regard the current location as a visit place when the duration is more than a visit threshold time.

The advertising server may include: a visit history manager; a visit place predictor; and an advertisement selector. The visit history manager may manage the visit place history provided from the advertising client. The visit place predictor may predict the next visit place based on the visit place history provided from the visit history manager. The advertisement selector may select an advertisement to be provided based on the next visit place predicted from the visit place predictor to provide the selected advertisement to the advertising client.

The advertising server may further include a visit history database. The visit history manager may store the visit place history provided from the advertising client in the visit history database. The visit history manager may search the visit history in the visit history database to provide the searched visit history to the visit place predictor.

The advertising server may further include an advertisement database. The advertisement database may store a plurality of advertisements. The advertisement selector may select at least one advertisement from the plurality of advertisements stored in the advertisement database based on the next visit place to provide the selected advertisement to the advertising client.

The advertising server may further include an advertisement usage statistics database. The advertising server may store advertisement providing statistics data provided from the advertising client in the advertisement usage statistics database.

Other features and aspects will be apparent from the following detailed description, the drawings, and the claims.

### BRIEF DESCRIPTION OF THE DRAWINGS

FIG. 1 is a diagram for describing an example of a location based advertisement.

FIG. 2 is a diagram for describing a method for providing an advertisement according to an exemplary embodiment of the present invention.

FIG. 3 is a flowchart showing a method for providing an advertisement according to an exemplary embodiment of the present invention.

FIG. 4 is a flowchart showing an example of collecting a visit place history of a mobile apparatus of FIG. 3.

FIG. 5 is a flowchart showing an example of detecting a current location of the mobile apparatus of FIG. 4.

FIG. 6 is a flowchart showing an example of generating a visit place history of a mobile apparatus based on the current location detected in FIG. 4.

FIG. 7 is a flowchart showing a method for providing an advertisement according to an exemplary embodiment of the present invention.

FIG. 8 is a flowchart of an example of predicting a next visit place through a Bayesian network based on the visit place history collected in FIG. 7.

FIGS. 9 to 12 are diagrams for describing a method for predicting a next visit place through the Bayesian network of the present invention.

FIG. 13 is a graph showing a difference in prediction accuracy depending on a change in the number of variables included in the Bayesian network.

FIG. 14 is a block diagram showing an advertisement providing system according to another exemplary embodiment of the present invention.

FIG. 15 is a block diagram showing an example of an advertising client of FIG. 14.

FIG. 16 is a block diagram showing, in detail, an example of the advertisement providing system of FIG. 14.

FIG. 17 is a diagram for describing advertisements provided and displayed to a mobile apparatus according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

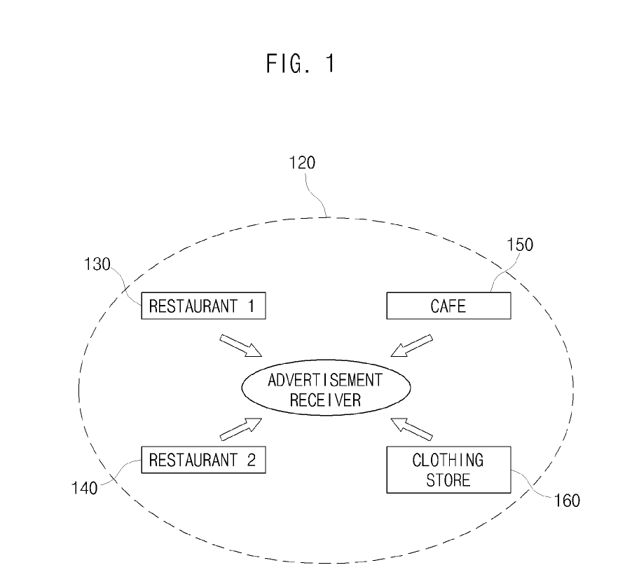

FIG. 1 is a diagram for describing an example of a location based advertisement.

Large-scale commercial complexes have huge potential for mobile advertising. COEX Mall, the largest commercial complex in South Korea, has more than 260 stores and attracts more than a hundred thousand visitors per day. From an advertisers' perspective, commercial complexes are strategically important places for advertising, because many people visit a commercial complex for the purpose of purchasing products or services. From a customers' perspective, mobile advertising can also help them to use a commercial complex in a more convenient way, since there are too many places to know well in detail.

Customer targeting may play a key role in order to effectively provide mobile advertisements in such a commercial complex. Through customer targeting, advertisers can identify people who will highly likely purchase a product and a service. Then, they can increase the effectiveness of the advertisement by focusing their efforts on those people. Also, customers can avoid spam ads.

Especially, for customer targeting at a commercial complex, spatial and temporal relevance of ads should be considered. If the category of an advertised place is interesting to a user and the place is closely located to the user, the ad will easily attract the user to visit the advertising place (spatial relevance). Also, if an advertised product or service will be highly likely consumed by a user soon, the ad will be able to immediately lead the user to actually purchase the product or service (temporal relevance).

Existing location-based advertisement delivers ads of nearby places depending on a user's current location. For example, as shown in FIG. 1, the mobile apparatus searches the location of a user (the advertisement receiver 110) and provides the searched location to an advertising server (not shown), and the advertising server searches advertisements for target places 130, 140, 150, and 160 located in an advertisement search area 120 based on the location of the advertisement receiver 110 received from the mobile apparatus to provide the searched advertisements to the mobile apparatus of the advertisement receiver 110.

However, the existing location-based advertisement is highly limited in effective targeting since the advertisement having low relevance is provided to the advertisement receiver 110. For example, if the advertisement receiver 110 is having a meal at the current location, ads for restaurants 130 and 140 would not be appealing.

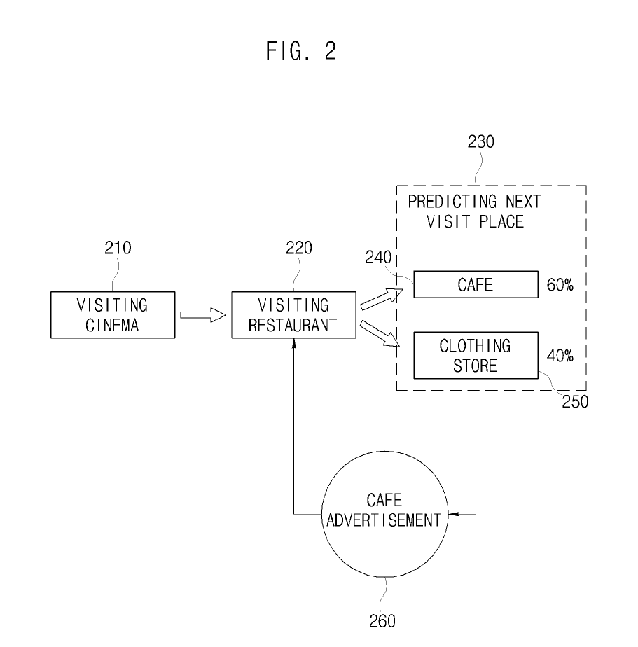

FIG. 2 is a diagram for describing a method for providing an advertisement according to an exemplary embodiment of the present invention.

According to an embodiment of the present invention, users' next visit place is predicted based on the places where the advertisement receiver has visited and spatially and temporally relevant ads are provided to the user to increase the advertising effect.

Referring to FIG. 2, the user (advertisement receiver) first visits a cinema 210 and thereafter, visits a restaurant 220. Since the advertisement receiver has already visited the cinema, a probability to visit the cinema again after the meal may be relatively low. Further, since the advertisement receiver is now visiting the restaurant, the advertisement receiver will highly likely not visit other restaurants consecutively. In this case, a film screening advertisement or an advertisement for another nearby restaurant is less effective to the user than an advertisement for another category.

In the advertisement providing method according to the exemplary embodiment of the present invention, a visit place history of the advertisement receiver is collected to predict the next visit place. Since an advertisement for a category relating to the predicted next visit place is provided to the advertisement receiver, the advertising effect increases. That is, in the example shown in FIG. 2, a history of the cinema visit (210) and the restaurant visit (220) is collected, and as a result, the next visit place is predicted (230). In the exemplary embodiment, a probability to visit a cafe (240) as the next visit place is calculated as 60% and a probability to visit a clothing store as the next visit place is calculated as 40%. In this case, based on the calculated probabilities of the next visit places, the cafe advertisement (260) is provided to the advertisement receiver.

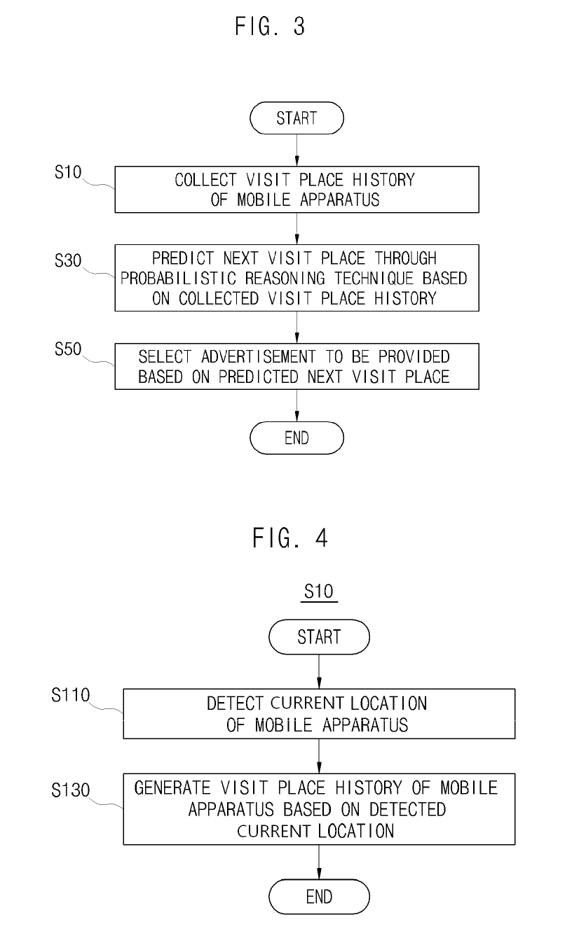

FIG. 3 is a flowchart showing a method for providing an advertisement according to an exemplary embodiment of the present invention.

Referring to FIG. 3, according to the exemplary embodiment of the present invention, a visit place history of a mobile apparatus is collected (step S10), a next visit place is predicted through probabilistic reasoning based on the collected visit place history (step S30), and an advertisement to be provided is selected based on the predicted next visit place (step S50). The advertisement providing method according to the exemplary embodiment of the present invention predicts the next visit place based on a past visit place history of the advertisement receiver and selects an advertisement having high relevance with the predicted next visit place to improve an advertisement effect.

The visit place history may be collected by the mobile apparatus. The mobile apparatus may be a smartphone, and further, may be a portable electronic apparatus such as a portable media player (PMP), an MP3 player, or a tablet computer which can be used to provide the advertisement to the user. In the exemplary embodiment, the visit place history may be collected by a global positioning system (GPS) mounted on the mobile apparatus. Or, the visit place history may be collected by a Wi-Fi receiver mounted on the mobile apparatus. A method for collecting the visit place history will be described below with reference to FIGS. 4 to 6.

It is difficult to predict the next visit place with certainty, because there is inherent uncertainty in human behaviors. Therefore, a probabilistic prediction model based on the collected visit place history is used. There are various probabilistic reasoning techniques such as a decision tree or conditional random fields (CRF). In the exemplary embodiment, as the probabilistic reasoning technique for predicting the next visit place, a Bayesian network may be used. A method for predicting the next visit place through the Bayesian network will be described with reference to FIGS. 8 to 13.

After the next visit place of the advertisement receiver is predicted, the advertisement to be provided to the advertisement receiver can be selected based on the predicted place. The selected advertisement may be one, or a plurality of advertisements may be selected with ranks. In an exemplary embodiment, when two or more advertisements are selected, the selected advertisements may be grouped for each category. Alternatively, the plurality of selected advertisements may be arranged depending on a distance from a current location.

FIG. 4 is a flowchart showing an example of collecting a visit place history of a mobile apparatus of FIG. 3.

Referring to FIG. 4, in order to collect the visit place history of the mobile apparatus, the current location of the mobile apparatus is detected (step S110) and the visit place history of the mobile apparatus may be generated based on the detected current location (step S130).

In this specification, a location is distinguished from a place. The location means a specific point having a coordinate detected by the mobile apparatus. Meanwhile, the place means a specific zone separated through a partition for a specific purpose. The place may include a plurality of coordinates and the place can be a cinema, restaurant, etc. In the advertisement providing method according to the exemplary embodiment of the present invention, in order to predict the next visit place, not just a history regarding the location but a detailed visit place, a detailed visit time, and a visit duration may be required. Since the location searched through the GPS or Wi-Fi receiver may not include information on the place, an operation for verifying a visit place where the mobile apparatus stays based on the detected current location may be required in order to collect the visit place history.

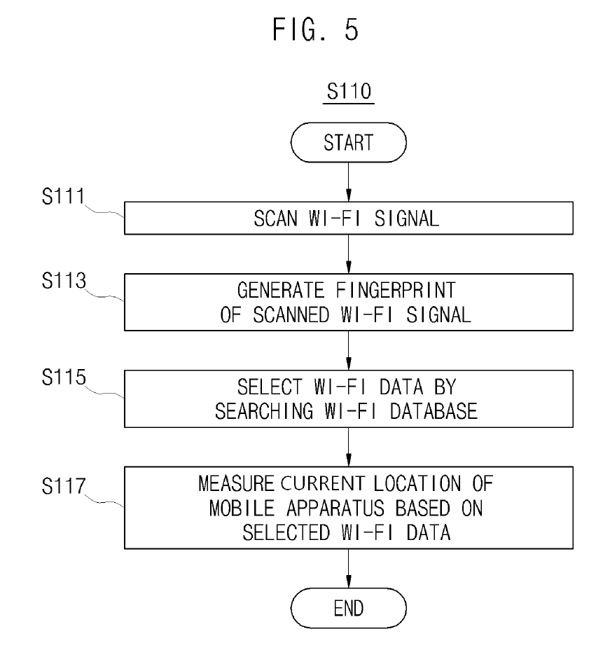

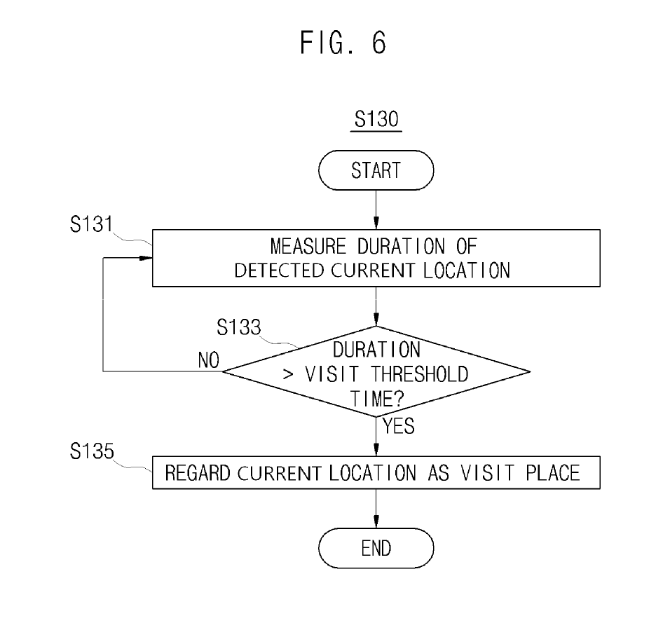

Specifically, the current location may be detected using a Wi-Fi communication system. General location system using a radio signal calculates coordinates, or latitude and longitude of the current location through a triangulation technique based on a plurality of radio signals received simultaneously. To verify the visit place where the mobile apparatus stays through a Wi-Fi communication system, Wi-Fi fingerprint is generated from the Wi-Fi signal and a Wi-Fi fingerprint database is searched based on the Wi-Fi fingerprint. A reference Wi-Fi fingerprint (we will call it Wi-Fi data) which is the most similar to the generated Wi-Fi fingerprint is searched from the Wi-Fi fingerprint database and a place associated with the searched fingerprint may be determined as the current visit place. A detailed method for verifying the current visit place through the Wi-Fi communication system will be described below with reference to FIGS. 5 and 6.

FIG. 5 is a flowchart showing an example of detecting a current location of a mobile apparatus of FIG. 4.

Referring to FIG. 5, a step of detecting the current location of the mobile apparatus through the Wi-Fi receiver is shown. In order to detect the current location of the mobile apparatus, a Wi-Fi signal is scanned by the mobile apparatus (step S111), a Wi-Fi fingerprint of the scanned Wi-Fi signal is generated (step S113), Wi-Fi data is selected based on the generated Wi-Fi fingerprint by searching a Wi-Fi database (step S115), and the current location of the mobile apparatus may be determined based on the searched Wi-Fi data (step S117).

In order to collect a visit place history of the mobile apparatus, the current location of the mobile apparatus may be detected. In the exemplary embodiment of the present invention, a Wi-Fi localization system may be used to detect the current location of the mobile apparatus. Furthermore, a GPS localization or Bluetooth localization technique may be used. However, since the Wi-Fi localization system can accurately detect the location even in an indoor place such as a large-scale commercial complex and has relatively high localization accuracy as compared with the GPS localization system, the Wi-Fi localization system may be used. As compared with the Bluetooth localization technology, since a plurality of Wi-Fi access points have already been deployed in the commercial complex, additional equipments do not need to be installed for localization.

The Wi-Fi fingerprint of the Wi-Fi signal may include information on the Wi-Fi access point (AP) and a received signal strength indicator (RSSI) included in one or more Wi-Fi signals received by the mobile apparatus. The information may include a media access control (MAC) address of the Wi-Fi access point. The Wi-Fi database may be searched by generating the Wi-Fi fingerprint of the received Wi-Fi signal. The Wi-Fi database as a database regarding the Wi-Fi fingerprint of the Wi-Fi signal may manage connection between the Wi-Fi fingerprint and a relevant visit place. To this end, the Wi-Fi database may include locational information of each Wi-Fi access point deployed in the commercial complex. The reference Wi-Fi fingerprint (we will call it Wi-Fi data) which is the most similar to the generated Wi-Fi fingerprint of the Wi-Fi signal may be selected by searching the Wi-Fi database. In the exemplary embodiment, the Wi-Fi data (i.e., the reference Wi-Fi fingerprint) may include the signal strength, an identification number, and the locational information of the Wi-Fi access point. When the Wi-Fi data includes the locational information of the corresponding Wi-Fi access point, the place relevant to the Wi-Fi fingerprint may be determined as the current visit place by measuring the location of the mobile apparatus based on the locational information.

FIG. 6 is a flowchart showing an example of generating a visit place history of a mobile apparatus based on the current location detected in FIG. 5.

Referring to FIG. 6, in the advertisement providing method according to the exemplary embodiment of the present invention, in order to generate the visit place history, duration of the detected current location is measured (step S131), and the measured duration of the current location is compared with a visit threshold time (step S133). When the measured duration is more than the visit threshold time, the detected current location is regarded as the visit place (step S135).

In order to selectively provide the advertisement based on the visit location history, it is not enough to search the current location of the mobile apparatus, and a process of verifying which place is visited in detail based on the current location may be further required. To this end, a process of detecting a place-in event and a place-out event may be required through the periodic detection on current location.

In the exemplary embodiment of the present invention, a place identification (ID) based on the detected current location may be searched in order to generate the visit place history. The place ID may be a serial number regarding a specific place and may include locations in a compartment of the specific place. For example, when the detected current location belongs to the inside of a specific restaurant, an ID of the restaurant may be searched as the place ID.

In case of updating the place ID by periodic search on the current location, the visit place history may be generated by recognizing the place as the visit place when the place ID is maintained without change for a predetermined time or more. For example, when an advertisement receiver having a mobile apparatus temporarily enters a restaurant to ask a menu and comes out, a place ID corresponding to the restaurant may be temporarily searched, but in this case, since there is no action of taking a meal at the restaurant, the case may not be recognized as ‘visiting’ the restaurant. That is, when the advertisement receiver stays at a specific place for a certain amount of time, the place is recognized as the visit place to generate the visit place history.

For example, when the place ID of the restaurant searched based on the current location is maintained for only a short time such as one minute, probability that the advertisement receiver took a meal at the restaurant may be relatively low. On the contrary, when the searched place ID has been stable for 40 minutes, it can be regarded that the advertisement receiver took a meal at the restaurant. The advertisement providing method according to the exemplary embodiment of the present invention may further include setting the visit threshold time to be compared with the measured duration. For example, in the above-mentioned example, the visit threshold time relating to the restaurant may be set to 30 minutes. In this case, when the duration is more than 30 minutes, the restaurant is regarded as the visit place to generate the visit place history. When the duration is less than 30 minutes, the current location is searched continuously without generating the visit place history and the duration of the current location is measured.

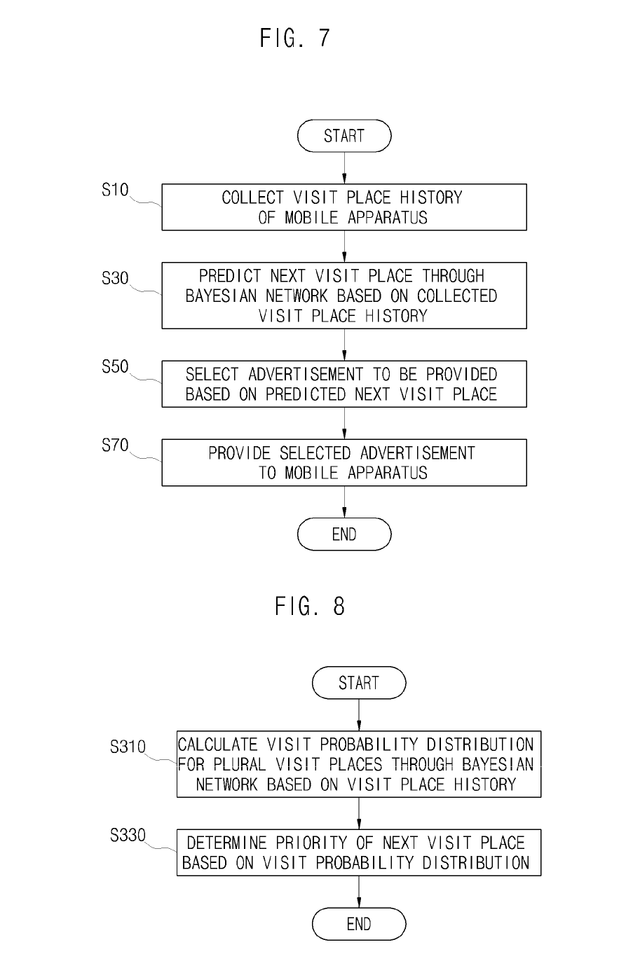

FIG. 7 is a flowchart showing a method for providing an advertisement according to an exemplary embodiment of the present invention.

Referring to FIG. 7, by the advertisement providing method according to the exemplary embodiment of the present invention, a visit place history of a mobile apparatus is collected (step S10), a next visit place is predicted through a Bayesian network based on the collected visit place history (step S30), an advertisement to be provided is selected based on the predicted next visit place (step S50), and the selected advertisement may be provided to the mobile apparatus (step S70). In FIG. 7, the process up to selecting the advertisement to be provided (S50) is the same as the process described above by referring to FIG. 3. The advertisement providing method according to the exemplary embodiment of the present invention may further include providing the selected advertisement to the mobile apparatus.

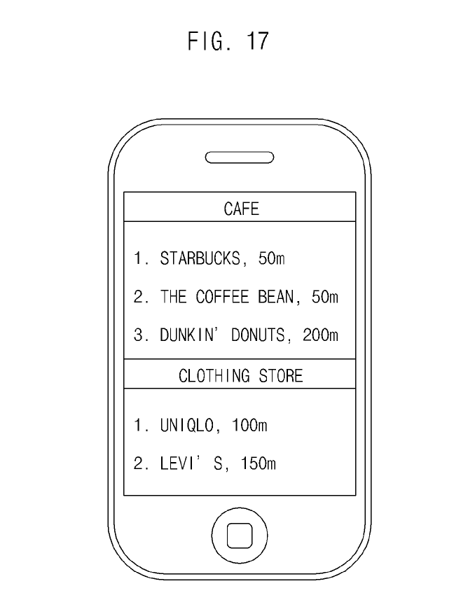

As described below, in predicting a next visit place, when a plurality of next visit places are predicted, a plurality of advertisements that belong to a category of the plurality of next visit places may be selected. For example, when a cafe and a clothing store are predicted as the next visit place, one or more advertisements that belong to a category of the cafe and one or more advertisements that belong to a category of the clothing store may be selected as the advertisement to be provided. In providing the selected advertisement to the mobile apparatus (S70) in FIG. 7, all or some of the plurality of advertisements may be provided to the mobile apparatus. The plurality of advertisements may be randomly provided to the mobile apparatus. In another exemplary embodiment, the advertisements are ranked to be provided to the mobile apparatus. As described below, when the plurality of advertisements are ranked to be provided to the mobile apparatus, the ranking may be determined in various methods. Providing the selected advertisement to the mobile apparatus will be described below with reference to FIG. 17.

In the exemplary embodiment, the advertisement providing method may further include collecting advertisement providing statistics data relating to the provided advertisement. The advertisement providing statistics data may include at least one of the total number of issued provided advertisements, the number of times in which the advertisement receiver uses the provided advertisement, and the number of times of purchases generated by providing the advertisement. The model of the Bayesian network may be updated by collecting the advertisement providing statistics data and a feedback of the advertisement receiver relating to the advertisement providing may be accepted.

FIG. 8 is a flowchart of an example of predicting a next visit place through a Bayesian network based on the visit place history collected in FIG. 7.

Referring to FIG. 8, in order to predict the next visit place according to the exemplary embodiment of the present invention, a visit probability distribution for a plurality of visit places is calculated through the Bayesian network based on at least one visit place history (step S310) and a priority of the next visit place may be determined based on the calculated visitation probability distribution (step S330).

In order to selectively provide the advertisement by predicting the next visit place of the advertisement receiver, in the advertisement providing method according to the exemplary embodiment of the present invention, the next visit place may be probabilistically predicted by using the Bayesian network (BN). The Bayesian network may mean a graphical model representing random variables and their conditional dependencies through a directed acyclic graph (DAG). In order to analyze a customer's actions which are inherent in some degree of uncertainty, the probabilistic model such as the Bayesian network may be appropriately used. As described above, as the probabilistic model for predicting the next place, various probabilistic reasoning techniques such as the decision tree or conditional random fields may be used in addition to the Bayesian network. That is, the advertisement providing method according to the present invention, predicting the next visit place is not limited to the Bayesian network technique.

Hereinafter, as the exemplary embodiment of the present invention, the method for predicting the next visit place through the Bayesian network will be described. The Bayesian network may be modeled to the directed acyclic graph including a node expressing the variables and an arc expressing a dependency relationship between the variables. One node may be a random variable, but one node may be various kinds of variables such as a measurement value, a constant, a factor, and a hypothesis.

The Bayesian network may be a model expressing a joint probability distribution for all variables expressed by the node on the graph. The Bayesian network model may be represented by Equation 1.

$$P ( V ) = {\prod }_{v ∈ V} P ( v \vert parents ( v ) ) \qquad [ Equation 1 ]$$

In Equation 1, ‘v’ written as a lower case letter may represent each node included in the Bayesian network model and ‘V’ written as an upper case letter may represent a set of the nodes v. ‘parents(v)’ may be a parent node of the node v. For example, when a directed arc from node A to node B exists, node A may be the parent node of node B.

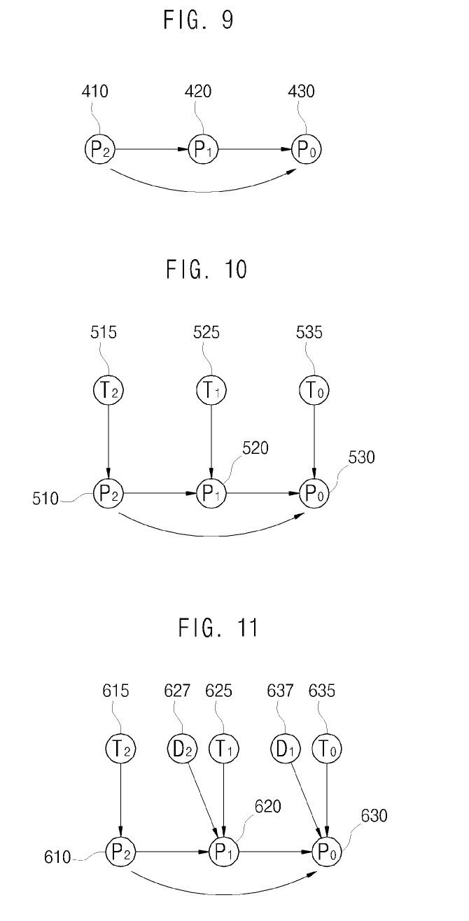

Prediction of the next visit place based on the past visit place history may be performed through the Bayesian network. The method for predicting the next visit place using the Bayesian network will be described below with reference to FIGS. 9 to 12.

FIGS. 9 to 12 are diagrams for describing a method for predicting a next visit place through the Bayesian network of the present invention.

In the model for predicting the next place shown in FIGS. 9 to 12, visit place, visit time, visit duration, gender, and ages may be considered. The visit place is denoted by ‘P’. In one example, P has four states, i.e., {clothing store, cafe, restaurant, cinema}. The visit time is denoted by ‘T’. In the exemplary embodiment, T has 24 states which are divided by hour. The visit duration is denoted by ‘D’. In the exemplary embodiment, D has 8 states whose maximum value is limited to 4 hours and each state is divided in 30 minutes chunk. Age is denoted by ‘A’. In the exemplary embodiment, A has 4 states, i.e., {under 20's, 20's, 30's, over 40's}. Gender is denoted by ‘G’ and has 2 states, i.e., {male, female}.

In the Bayesian network model for predicting the next place shown in FIGS. 9 to 12, the current visit place, visit time, and visit duration may be represented by P₀, T₀, and D₀, respectively. i-th previous visit place, visit time, and visit duration from the present may be represented by Pᵢ, Tᵢ and Dᵢ respectively. For example, the just-before visit place may be represented by P₁ and a visit place just before visiting P₁ may be represented by P₂. A and G have characteristics which is constant for individual users. On the contrary, P, T, and D vary continuously.

Referring to FIG. 9, topology of the Bayesian network model for a case of sequentially visiting three places is shown. In the Bayesian network model shown in FIG. 9, only the previous visit place influences the next visit place. As described above, it is assumed that each of the visit places P₀, P₁, and P₂ has four states, i.e., {clothing store, cafe, restaurant, cinema}. Since there are total three nodes of P₀ 430, P₁ 420, and P₂ 410 in the Bayesian network model and each node may have four possible states, total of 4³, i.e., 64 variable results may be combined with each other. An arrow connecting the nodes to each other represents the above-mentioned arc and each arrow represents a probabilistic relationship between two nodes connected by the arrow.

In the model of FIG. 9, parent nodes of node P₀ 430 are P₁ 420 and P₂ 410 and a parent node of node P₁ 420 is P₂ 410. Therefore, based on Equation 1, the probabilistic relationship of the Bayesian network model shown in FIG. 9 may be represented by including multiplication of the conditional probability as shown in Equation 2 below.

P(P₀,P₁,P₂)=P(P₀|P₁P₂)·P(P₁|P₂)·P(P₂) [Equation 2]

In Equation 2, P₀, P₁, and P₂ represent the visit places corresponding to the nodes in the graph.

The probabilistic relationship for each of the combined variables may be empirically acquired. As a result, before predicting the next visit place of the advertisement receiver in order to actually provide the advertisement, learning or training the Bayesian network model is performed in advance. The learning or training of the Bayesian network model may mean configuring topology of a graph based on given learning data and configuring a conditional probability table (CPT) for a dependency relationship that exists between the nodes. The learning data may mean a plurality of data that are empirically acquired. That is, the learning of the Bayesian network model may be performed based on visit place histories collected from a plurality of advertisement receivers.

In the exemplary embodiment, when a prediction model of the Bayesian network is learned, both configuring the topology of the graph and configuring the conditional probability table may be performed based on given learning data. In another exemplary embodiment, while the topology of the graph is prepared, only the conditional probability table may be configured based on the given learning data. In the learning step, when only the conditional probability table is configured, the learning may be more easily performed.

When sequential visit pattern information of a predetermined user is given, a probability distribution of a place to be visited next may be calculated based on the learned prediction model. For example, in FIG. 9, when the present user is positioned at node P₁, prediction of the next visit place, P₀ may be acquired from the learned prediction model. The visit place of the user may be influenced by the previous visit place. For example, when P₂ 410 is the restaurant, a probability that P₁ 420 or P₀ 430 will be the restaurant becomes relatively low. In this case, a probability that P1 420 and P0 430 will be shown as patterns of the cinema and the cafe, respectively or shown as the cafe and the clothing store, respectively may be relatively high. The sequential visit pattern may be learned by collecting a visit place history of another person and by observing a common sequential visit pattern, the next visit place may be probabilistically predicted based on the present and previous visit place histories.

When the next visit place is predicted through the prediction model of the Bayesian network in the same manner as the above-mentioned method, prediction accuracy can be improved, and as a result, advertisements having a high advertisement effect can be selectively provided to the user. In the exemplary embodiment, the prediction model, i.e., the probability distribution model of the Bayesian network may be learned based on the previous visit place histories of the corresponding advertisement receiver. In the exemplary embodiment, the probability distribution model of the Bayesian network may be learned based on visit place histories of other advertisement receivers.

In the example of FIG. 9, the Bayesian network model including only three visit place nodes is shown. For more accurate prediction of the next visit place, a factor influencing the sequential visit pattern may be further included as a variable corresponding to the node of the Bayesian network model. For example, the current time and a time when the previous visit place is visited may influence the next visit place selected by the user. For example, when the current time is 6 p.m., a probability that the restaurant will be selected as the next visit place may be relatively high as compared with when the current time is 3 p.m.

Referring to FIG. 10, visit times, T₀ 535, T₁ 525, and T₂ 515 corresponding to the visit places, P₀ 530, P₁ 520, and P₂ 510, respectively may be further included as a node in the graph of the Bayesian network model as described above.

In the Bayesian network model shown in FIG. 10, parent nodes of node P₀ 530 are P₁ 520, P₂ 510, and T₀ 535, parent nodes of node P₁ 520 are P₂ 510 and T₁ 525, and a parent node of node P₂ 510 is T₂ 515. Therefore, based on Equation 1, the probabilistic relationship of the Bayesian network model shown in FIG. 10 may be represented by Equation 3 below.

P(P₀,P₁,P₂,T₀,T₁,T₂)=P(P₀|P₁,P₂,T₀)·P(P₁|P₂,T₁)·P(P₂|T₂) [Equation 3]

A visit duration corresponding to the duration when the user stays at each of the visit places is included as a variable in addition to the visit time for each visit place to perform more accurate prediction.

Referring to FIG. 11, the graph of the Bayesian network model is shown, which further includes D₁ 637 and D₂ 627 which are visit durations when the user stayed at the previous visit places P₁ 620 and P₂ 610, respectively, as the nodes as described above. In the graph of FIG. 11, the current visit place, P, is shown as D₁+₁ which is a visit duration when the user stays at the previous visit place, Pᵢ₊₁. That is, D₂ 627 which is the duration when the user stays at P₂ 610 influences not P₂ 610 but P₁ 620. Therefore, D₂ 627 may be a parent node of not P₂ 610 but P₁ 620.

In the Bayesian network model shown in FIG. 11, the parent nodes of node P₀ 630 are P₁, 620, P₂ 610, T₀ 635, and D₁ 637, the parent nodes of node P₁ 620 are P₂ 610, T₁ 625, and D₂ 627, and the parent node of node P₂ 610 is T₂ 615. Therefore, based on Equation 1, the probabilistic relationship of the Bayesian network model shown in FIG. 11 may be represented by Equation 4 below.

P(P₀,P₁,P₂,T₀,T₁,T₂,D₁,D₂)=P(P₀|P₁,P₂,T₀,D₁)·P(P₁|P₂,T₁,D₂)·P(P₂|T₂) [Equation 4]

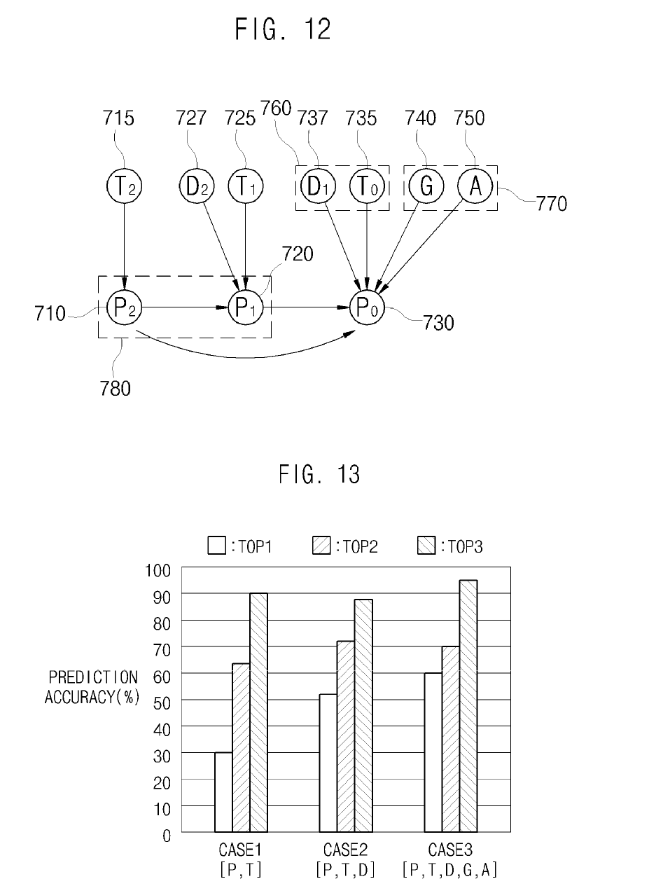

Age and gender of the user in addition to the past visit place, visit time, and visit duration may also influence selection of the next visit place. Since the age A and gender G of the user are not the variables which are changed with movement of the place or the passage of the time, graph topology shown in FIG. 12 may be exemplarily configured in the case of modeling the Bayesian network including the age and gender.

The graph shown in FIG. 12 is similar to the graph of FIG. 11, but the age A 750 and the gender G 740 are further included as nodes that influence the selection of the current visit place P₀ 730. In FIG. 12, variables that influence the current visit place P0 730 may be divided into three categories. The previous visit places, P1 720 and P2 710 are a spatial variable 780, the current time T0 735 and the previous visit duration D1 737 are a temporal variable 760, and the age A 750 and the gender G 740 may be determined as a profile variable 770.

In the method similar to methods described in FIGS. 9 to 11, based on Equation 1, the probabilistic relationship of the Bayesian network model shown in FIG. 12 may be represented by Equation 5 below.

P(P₀,P₁,P₂,T₀,T₁,T₂,D_{c1},D₂,G,A)=P(P₀|P₁,P₂,T₀,D₁,G,A)·P(P₁|P₂,T₁,D₂)·P(P₂|T₂) [Equation 5]

As described above with reference to FIGS. 9 to 12, since the next visit place of the advertisement receiver may be probabilistically predicted through the Bayesian network, more accurate customer targeting can be achieved. That is, by the advertisement providing method according to the exemplary embodiment of the present invention, since the advertisement may be selectively provided by accurate customer targeting, it is possible to increase the convenience of the advertisement receiver while improving the advertisement effect. In order to predict the next visit place more accurately, the variables used for prediction may be increased. That is, more previous visit place histories may be used to predict the next visit place and various other variables may be included in the Bayesian network model.

Meanwhile, the advertisement providing method according to the exemplary embodiment of the present invention is implemented as a program command format which can be executed in various computing systems to be recorded in computer-readable recording media. These computer-readable recording media may be implemented as magnetic recording media such as a hard disk, a floppy disk, and a magnetic tape, optical recording media such as a CD-ROM and a DVD, a magneto-optical recording medium such as a floptical disk, or hardware devices manufactured to store and execute program commands. The above method may include collecting a visit place history of a mobile apparatus, predicting a next visit place through a Bayesian network based on the collected visit place history, and selecting an advertisement to be provided based on the predicted next visit place.

FIG. 13 is a graph showing a difference in prediction accuracy depending on a change in the number of variables included in the Bayesian network.

For an experiment for investigating prediction accuracy, sequential visit place histories of approximately 130 COEX Mall users are actually collected. Histories of visitors for three places or less are removed from the histories of the 130 persons. Histories of the duplicate visitors showing the same circulation as companies are removed. Visit histories of 76 users are acquired through filtering. The total number of visits of the users is 351. 80% of the visit place histories are used for learning of the Bayesian network model and the rest of the visit place histories, 20% are used for test data. That is, by using the Bayesian network modeled from the 80% data, predicting next visit places of the rest of the user, 20% is compared with places which the 20% users visit actually. In order to prepare a result graph, three next visit places are predicted by giving a priority on the basis of the probability according to the exemplary embodiment of the present invention.

FIG. 13 shows prediction accuracies for three cases. CASE 1 only considers visit place P and visit time T. CASE 2 includes visit place P, visit time T, and visit duration D. CASE 3 includes all the features, i.e., visit place P, visit time T, visit duration D, gender G, and age A.

In FIG. 13, a bar graph written as TOP1 means the percentage accuracy that the next visit place is correctly predicted as the first rank (i.e., the highest probability), TOP2 means the percentage accuracy that the next visit place is correctly predicted within the second rank (i.e., the second highest probability), and TOP3 means the percentage accuracy that the next visit place is correctly predicted within the third rank (i.e., the third highest probability). represents a ratio in which a first-priority visit place having the highest probability among the predicted places coincides with the actual visit place.

Therefore, prediction results that belong to TOP1, TOP2, and TOP3 are not exclusive to each other but correspond to an inclusive relationship. That is, a result that belongs to TOP1 is included in even TOP2 and TOP3. Further, a result that belongs to TOP2 is included in even TOP3. For example, in the case where the next visit place is predicted according to priorities of the cafe, the clothing store, the cinema, and other places, a case where the user actually visits the cinema corresponds to only TOP3. Meanwhile, a case where the user actually visits the cafe corresponds to all of TOP1, TOP2, and TOP3.

Referring to FIG. 13, prediction accuracies of CASE 3 for TOP1 and TOP3 are 59.45% and 94.59%, respectively, and the highest as compared with CASE 1 and CASE 2. Therefore, in the case of CASE 3, it can be seen that an advertisement which has relevance with the advertisement receiver may be provided as the probability of 94.59% when advertisements relating to three upper visit places predicted are provided. According to the result of FIG. 13, when the prediction model of the Bayesian network is configured, as more variables relating to selection of the next visit place are included, the prediction accuracy may be improved. Further, when more previous visit places are included as the variables, the prediction accuracy may be improved. However, as more variables are adopted, the topology of the prediction model may be complicated and a calculation amount may be increased. For example, when information on previous visit places which are more than three is configured as the Bayesian network model, performance may be relatively less improved as compared with the increased calculation amount and information storage space. As a result, types and the number of variables included in the Bayesian network model may be appropriately determined by considering the advertisement effect, the prediction accuracy, and the calculation complexity.

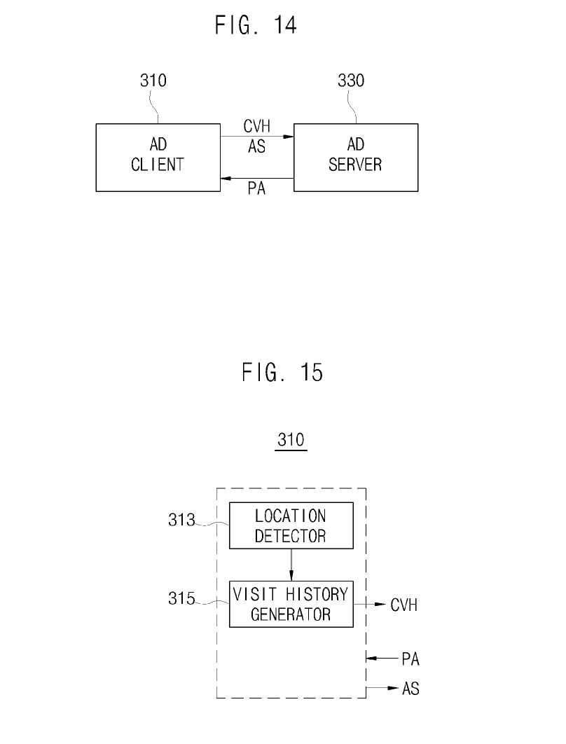

FIG. 14 is a block diagram showing an advertisement providing system according to another exemplary embodiment of the present invention.

Referring to FIG. 14, the advertisement providing system includes an advertising client 310 and an advertising server 330. The advertising client 310 collects a visit place history CVH and provides the collected visit place history to the advertising server 330, and receives an advertisement PA from the advertising server 330. The advertising server 330 predicts a next visit place through a Bayesian network based on the visit place history CVH received from the advertising client 310 and provides the advertisement PA to the advertising client 310 based on the predicted next visit place.

In the exemplary embodiment, the advertising client 310 may provide advertisement providing statistics data AS relating to the use of the provided advertisement PA to the advertising server 330. The advertising server 330 may collect and store the advertisement providing statistics data AS. The advertisement providing statistics data AS may include at least one of the total number of issued provided advertisements, the number of times in which the advertisement receiver uses the provided advertisement, and the number of times of purchases generated by providing the advertisement.

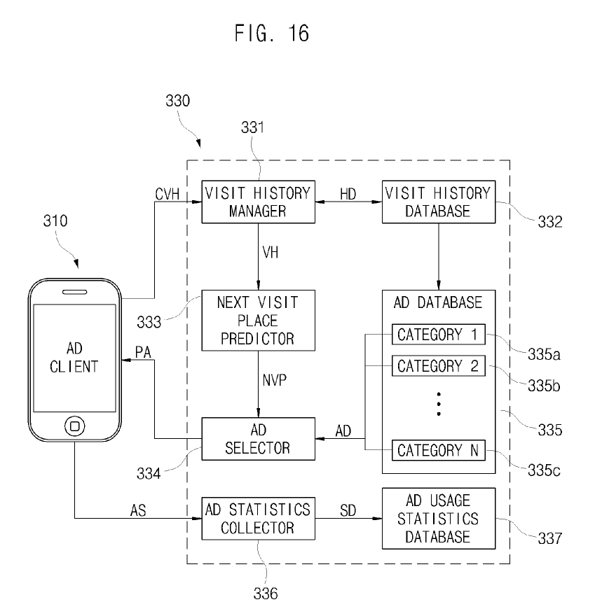

FIG. 15 is a block diagram showing an example of an advertising client of FIG. 14.

Referring to FIG. 15, the advertising client 310 may include a location detector 313 and a visit history generator 315. The location detector 313 may detect a current location of the advertising client. The visit history generator 315 may generate the visit history CVH based on the detected current location. As described with reference to FIG. 14, the advertising client 310 may receive the advertisement PA provided from the advertising server. In the exemplary embodiment, the advertising client 310 may provide advertisement providing statistics data AS relating to the use of the provided advertisement PA to the advertising server 330.

In the advertisement providing system using a mobile apparatus, the advertising client 310 may include the mobile apparatus which an advertisement receiver possesses. As a result, the advertising client 310 may be a device including a portable apparatus such as a smartphone, a portable media player, an MP3 player, or a tablet computer, or the like. Therefore, although not shown in FIG. 15, the advertising client 310 may further include a display apparatus processing and outputting the advertisement PA received from the advertising server. Further, the advertising client 310 may further include an input apparatus that receives an input from the user of the mobile apparatus.

In the exemplary embodiment, the location detector 313 may include a GPS receiver or a Wi-Fi receiver detecting the current location of the advertising client 310. In the exemplary embodiment, the location detector 313 is connected with the GPS receiver or Wi-Fi receiver to receive and process locational information. The location detector 313 may periodically detect the current location and provide the detected current location to the visit history generator 315.

The visit history generator 315 generates the visit history CVH of the advertising client 310 based on the current location received from the location detector 313 to provide the generated CVH to the advertising server. In the exemplary embodiment, the method described above with reference to FIG. 6 may be used in order to generate the visit history CVH. The visit history generator 315 measures duration of the current location based on the current location periodically provided from the location detector 313 and may regard the measured current location as a visit place when the measured duration is more than a visit threshold time. As a result, the visit history CVH is generated as data to be provided to the advertising server.

FIG. 16 is a block diagram showing, in detail, an example of the advertisement providing system of FIG. 14.

Referring to FIG. 16, the advertisement providing system includes the advertising client 310 and the advertising server 330. The advertising server 330 may include a visit history manager 331, a next visit place predictor 333, and an advertisement selector 334. The visit history manager 331 may manage the visit history CVH provided from the advertising client 310. The next visit place predictor 333 may predict a next visit place NVP through the Bayesian network based on the visit history provided from the visit history manager 331. The advertisement selector 334 selects an advertisement PA to be provided based on the predicted next visit place NVP to provide the selected advertisement PA to the advertising client 310.

Continuously referring to FIG. 16, the advertising server 330 may further include a visit history database 332, an advertisement database 335, an advertisement statistics collector 336, and an advertisement usage statistics database 337. Visit place histories HD of the advertising client 310 may be stored in the visit history database 332. The visit place history HD may be stored by the visit history manager 331. The visit history manager 331 detects the visit place histories HD stored in the visit history database 332 to provide the detected visit place histories HD to the visit place predictor 331.

The advertisement database 335 may include a plurality of advertisement categories. The plurality of advertisement categories may include category 1 335a, category 2 335b to category N 335c. The advertisement categories may correspond to a plurality of visit places, respectively. For example, category 1 335a and category 2 335b may be the advertisement categories corresponding to a cinema and a restaurant, respectively. Each of advertisement categories 335a to 335c may include one or more advertisements. For example, category 1 335a may include advertisements for one or more cinemas.

The advertisement selector 333 may search the advertisement database 335 based on one or more next visit place NVP provided from the visit place predictor 333. The advertisement database 335 may provide advertisements AD of a category relating to the next visit place NVP to the advertisement selector 333. The advertisement selector processes the advertisements searched in the advertisement database 335 to provide the processed advertisements to the advertising client 310.

As described above, the advertising client 310 may provide the advertisement providing statistics data AS relating to the use of the provided advertisement PA to the advertising server 330. The advertising server 330 may collect and store the advertisement providing statistics data AS. Specifically, the advertising client 310 provides the advertisement providing statistics data AS to the advertisement statistics collector 336 of the advertising server 330 and the advertisement statistics collector 336 processes the advertisement providing statistics data AS to store the processed advertisement providing statistics data in the advertisement usage statistics database 337 as statistics data SD. The advertisement providing statistics data AS may include at least one of the total number of issued provided advertisements, the number of times in which the advertisement receiver uses the provided advertisement, and the number of times of purchases generated by providing the advertisement.

The statistics data SD stored in the advertisement usage statistics database 337 may be usefully used in order to provide the advertisement more preferably. For example, the statistics data SD may be used to improve the Bayesian network model for predicting the next visit place and may be used as data for feedback to an advertiser.

FIG. 17 is a diagram for describing advertisements provided and displayed to a mobile apparatus according to an exemplary embodiment of the present invention.

Referring to FIG. 17, the mobile apparatus 410 may include a display unit 415. The mobile apparatus 410 may include the advertising client. In FIG. 17, an example in which 5 advertisements provided from the advertising server are displayed on the display unit 415 is shown. The 5 advertisements may belong to 2 advertisement categories. That is, in FIG. 17, advertisements for STARBUCKS, The Coffee Bean, and DUNKIN' DONUTS belong to a cafe category and UNIQLO and LEVI'S belong to a clothing store category. The cafes and clothing stores may be next visit places predicted by the Bayesian network according to the exemplary embodiment of the present invention. For example, by the Bayesian network, when the cafe and the clothing store are predicted as 60% and 40%, respectively as the next visit places, the weight of the advertisements that belong to the corresponding category may be determined and provided according to the predicted probabilities. That is, the advertisements of the cafes and the clothing stores may be provided as the ratios of 60% and 40%.

The advertisements that belong to each category may be displayed randomly or displayed according to a predetermined rule. For example, as shown in FIG. 17, the advertisements in the category may be displayed in order of being close to a current location. In FIG. 17, since STARBUCKS is positioned apart from the current location by 50 m and DUNKIN' DONUTS is positioned apart from the current location by 200 m, STARBUCKS is placed and displayed above DUNKIN' DONUTS. The exemplary embodiment of FIG. 17 is an example of a method of displaying one or more advertisements provided from the advertising client and further, the advertisement may be provided to the advertising client in various methods and the provided advertisement may be displayed.

The present invention can be usefully used to provide an advertisement using a mobile apparatus. In particular, the present invention can be applied to an advertisement providing business through a portable communication apparatus such as a smart phone and further, can be widely used to provide the advertisements using portable electronic apparatuses such as a cellular phone, a portable media player (PMP), an MP3 player, a notebook, a tablet computer.

According to exemplary embodiments of the present invention, a method for providing an advertisement predicts a next visit place based on a visit place history of an advertisement receiver and selectively provides an advertisement relating to the predicted next visit place to improve an advertisement effect. Further, the method can reduce a possibility of providing a spam advertisement.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing an advertisement, comprising:
collecting a visit place history of a mobile apparatus;
predicting a next visit place through a probabilistic reasoning technique based on the collected visit place history; and
selecting an advertisement to be provided based on the predicted next visit place.

2. The method of claim 1, wherein the collecting of the visit place history includes:
detecting a current location of the mobile apparatus; and
generating the visit place history of the mobile apparatus based on the detected current location.

3. The method of claim 2, wherein the detecting of the current location of the mobile apparatus includes:
scanning a Wi-Fi signal through the mobile apparatus;
generating a Wi-Fi fingerprint of the scanned Wi-Fi signal;
selecting Wi-Fi data based on the generated Wi-Fi fingerprint by searching a Wi-Fi database; and
measuring the current location of the mobile apparatus based on the selected Wi-Fi data.

4. The method of claim 3, wherein the Wi-Fi data includes signal strength of a Wi-Fi access point (AP), an identification number of the Wi-Fi access point (AP), and locational information of the Wi-Fi access point.

5. The method of claim 3, wherein the generating of the visit place history of the mobile apparatus includes:
measuring a duration of the measured current location;
comparing the measured duration with a visit threshold time; and
regarding the measured current location as a visit place when the measured duration is more than the visit threshold time.

6. The method of claim 5, wherein the generating of the visit place history of the mobile apparatus further includes setting the visit threshold time to be compared with the measured duration.

7. The method of claim 1, wherein the predicting of the next visit place through the probabilistic reasoning technique includes probabilistically predicting the next visit place through a Bayesian network.

8. The method of claim 7, wherein:
the Bayesian network is modeled by including a plurality of visit places as variables, and
the predicting of the next visit place through the Bayesian network based on the collected visit place history includes:
calculating a visit probability distribution for the plurality of visit places through the Bayesian network based on the one or more visit place histories; and
determining a priority of the next visit place based on the calculated visit probability distribution.

9. The method of claim 8, wherein the Bayesian network for calculating the probability distribution is learned based on the visit place histories of the corresponding advertisement receiver.

10. The method of claim 8, wherein the Bayesian network for calculating the probability distribution is learned based on the visit place histories of other advertisement receivers.

11. The method of claim 8, wherein:
the Bayesian network is modeled by further including the ages of the advertisement receiver as a variable, and
the visit probability distribution is calculated based on the one or more visit place histories and the ages.

12. The method of claim 8, wherein:
the Bayesian network is modeled by further including the gender of the advertisement receiver as a variable, and
the visit probability distribution is calculated based on the one or more visit place histories and the gender.

13. The method of claim 8, wherein:
the Bayesian network is modeled by further including a current time as a variable, and
the visit probability distribution is calculated based on the one or more visit place histories and the current time.

14. The method of claim 8, wherein:
the Bayesian network is modeled by further including visit duration as a variable, and
the visit probability distribution is calculated based on the one or more visit place histories and the visit duration.

15. The method of claim 8, wherein the selecting of the advertisement to be provided includes preparing an advertisement list relating to the next visit place based on the determined priority.

16. The method of claim 15, further comprising providing advertisements included in the prepared advertisement list to the mobile apparatus according to the priority.

17. The method of claim 16, further comprising collecting advertisement providing statistics data relating to the provided advertisement.

18. The method of claim 17, wherein the advertisement providing statistics data includes at least one of the total number of issued provided advertisements, the number of times in which the advertisement receiver uses the provided advertisement, and the number of times of purchases generated by providing the advertisement.

19. A computer-readable recording medium including a program for executing an advertisement providing method, wherein the advertisement providing method includes:
collecting a visit place history of a mobile apparatus;
predicting a next visit place through a probabilistic reasoning technique based on the collected visit place history; and
selecting an advertisement to be provided based on the predicted next visit place.

20. The computer-readable recording medium of claim 19, wherein the visit place history is collected by a Wi-Fi fingerprint of a Wi-Fi signal received through the mobile apparatus.

21. The computer-readable recording medium of claim 19, wherein:
the predicting of the next visit place through the probabilistic reasoning technique based on the collected visit place history includes probabilistically predicting the next visit place based on a conditional probability distribution of a Bayesian network, and
a probability distribution model of the Bayesian network is learned based on the visit place histories of advertisement receivers.

22. The computer-readable recording medium of claim 19, wherein the advertisement providing method further includes providing the selected advertisement to the advertisement receiver.

23. An advertisement providing system, comprising:
an advertising client collecting a visit place history to provide the collected visit place history to an advertising server and receiving an advertisement from the advertising server; and
the advertising server predicting a next visit place through a Bayesian network based on the visit place history received from the advertising client and providing the advertisement to the advertising client based on the predicted next visit place.

24. The system of claim 23, wherein the advertising client includes:
a location detector detecting a current location; and
a visit history generator generating the visit place history based on the detected current location.

25. The system of claim 24, wherein the location detector
generates a Wi-Fi fingerprint by scanning a Wi-Fi signal, and
selects Wi-Fi data having high relevance with the generated Wi-Fi fingerprint and measures the current location based on the selected Wi-Fi data.

26. The system of claim 25, wherein the visit history generator measures a duration of the measured current location and regards the current location as a visit place when the duration is more than a visit threshold time.

27. The system of claim 23, wherein the advertising server includes:
a visit history manager managing the visit place history provided from the advertising client;
a visit place predictor predicting the next visit place through the Bayesian network based on the visit place history provided from the visit history manager; and
an advertisement selector selecting an advertisement to be provided based on the next visit place predicted from the visit place predictor to provide the selected advertisement to the advertising client.

28. The system of claim 27, wherein:
the advertising server further includes a visit history database, and
the visit history manager stores the visit place history provided from the advertising client in the visit history database and searches the visit history in the visit history database to provide the searched visit history to the visit place predictor.

29. The system of claim 27, wherein:
the advertising server further includes an advertisement database,
the advertisement database stores a plurality of advertisements, and
the advertisement selector selects at least one advertisement from the plurality of advertisements stored in the advertisement database based on the next visit place to provide the selected advertisement to the advertising client.

30. The system of claim 27, wherein:
the advertising server further includes an advertisement usage statistics database, and
the advertising server stores advertisement providing statistics data provided from the advertising client in the advertisement usage statistics database.
